(19) United States
(12) Patent Application Publication
(10) Pub. No.: US 2026/0320817 A1
(43) Pub. Date: Oct. 15, 2026

(54) ESTIMATION DEVICE, ESTIMATION METHOD, AND RECORDING MEDIUM

(71) Applicant: NEC Corporation, Tokyo (JP)

(72) Inventor: Shusuke MATSUDA, Tokyo (JP)

(73) Assignee: NEC Corporation, Tokyo (JP)

(21) Appl. No.: 19/634,265

(22) Filed: Mar. 31, 2026

(30) Foreign Application Priority Data
Apr. 10, 2025 (JP) 2025-064942

(51) Int. Cl. G06T 7/70; G06V 10/74

(52) U.S. Cl. CPC G06T 7/70; G06V 10/761; G06T 2207/30242

(57) ABSTRACT

An estimation device including: at least one memory configured to store instructions; and at least one processor configured to execute the instructions to: estimate a number of shelf labels installed on a fixture and an interval between the shelf labels as an article section on the fixture by performing image recognition on an image of the fixture captured by an imaging device; acquire an imaging distance from the imaging device to the fixture when the image is captured; specify an error in posture correction of the imaging device, based on the imaging distance; and estimate the article section on the fixture by dividing a width of the fixture by the number of shelf labels in a case where the estimated interval between the shelf labels is less than the error.

This application is based upon and claims the benefit of priority from Japanese Patent Application No. 2025-064942, filed on Apr. 10, 2025, the disclosure of which is incorporated herein in its entirety by reference.

### TECHNICAL FIELD

The present disclosure relates to an estimation device and the like.

### BACKGROUND ART

For example, there is a technique in which an imaging device captures an image of a fixture or the like in a facility such as a store, and a section or the like of a product is estimated from the captured image. For example, JP 2020-194565 A describes a technique for recognizing shelf labels by image analysis and counting the number of shelf labels.

### SUMMARY

For example, in a case where articles are placed on a shelf board at a high density, an interval between the articles is narrow, and thus an interval between the shelf labels is also narrow. When the interval between the shelf labels is narrow, it may sometimes be difficult to estimate an article section by using the shelf labels.

An exemplary object of the present disclosure is to provide an estimation device and the like that enable estimation of an article section even in a case where articles are placed at a high density on a fixture.

An estimation device according to one aspect of the present disclosure
includes
a first estimation unit for estimating a number of shelf labels installed on a fixture and an interval between the shelf labels as an article section on the fixture by performing image recognition on an image of the fixture captured by an imaging device,
an acquisition unit for acquiring an imaging distance from the imaging device to the fixture when the image is captured,
a specifying unit for specifying an error in posture correction of the imaging device, based on the imaging distance, and
a second estimation unit for estimating the article section on the fixture by dividing a width of the fixture by the number of shelf labels in a case where the estimated interval between the shelf labels is less than the error.

An estimation method according to one aspect of the present disclosure includes, by a computer,
estimating a number of shelf labels installed on a fixture and an interval between the shelf labels as an article section on the fixture by performing image recognition on an image of the fixture captured by an imaging device,
acquiring an imaging distance from the imaging device to the fixture when the image is captured,
specifying an error in posture correction of the imaging device, based on the imaging distance, and
estimating the article section on the fixture by dividing a width of the fixture by the number of shelf labels in a case where the estimated interval between the shelf labels is less than the error.

A program according to one aspect of the present disclosure causes a computer
to execute
estimating a number of shelf labels installed on a fixture and an interval between the shelf labels as an article section on the fixture by performing image recognition on an image of the fixture captured by an imaging device,
acquiring an imaging distance from the imaging device to the fixture when the image is captured,
specifying an error in posture correction of the imaging device, based on the imaging distance, and
estimating the article section on the fixture by dividing a width of the fixture by the number of shelf labels in a case where the estimated interval between the shelf labels is less than the error.

The program may be stored in a non-transitory computer-readable recording medium.

### BRIEF DESCRIPTION OF THE DRAWINGS

FIG. 1 is an explanatory diagram illustrating an example of an estimation system including an estimation device;

FIG. 2 is a block diagram illustrating a configuration example of the estimation device;

FIG. 3 is an explanatory diagram illustrating an example of a fixture;

FIG. 4 is an explanatory diagram illustrating an example in which a barcode capable of identifying a fixture is attached to a shelf board of the fixture;

FIG. 5 is an explanatory diagram representing the number of captured images and an angle error in posture;

FIG. 6 is an explanatory diagram illustrating an example of an evaluation result on the angle error in posture;

FIG. 7 is a flowchart illustrating an operation example of the estimation device;

FIG. 8 is a block diagram illustrating another configuration example of the estimation device; and

FIG. 9 is an explanatory diagram illustrating a hardware configuration example of a computer.

### EXAMPLE EMBODIMENT

Hereinafter, example embodiments of an estimation device, an estimation method, a program, and a non-transitory recording medium recording the program according to the present disclosure will be described in detail with reference to the drawings. The example embodiments do not limit the disclosed technique.

### Example Embodiment

In an example embodiment, an example of a function of an estimation device will be described in detail with reference to the drawings.

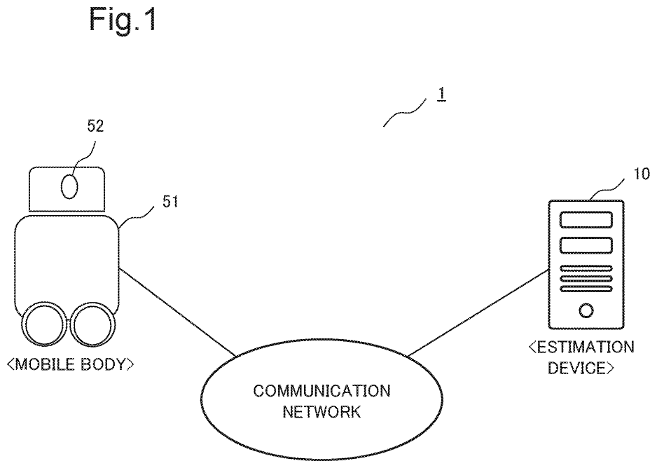

FIG. 1 is an explanatory diagram illustrating an example of an estimation system 1 including an estimation device 10. The estimation system 1 includes, for example, the estimation device 10 and a mobile body 51. The mobile body 51 includes an imaging device 52 that images a fixture in a facility. The facility is not particularly limited and may be a store, a warehouse, or the like. If the facility is a store, an article is a product. If the facility is a warehouse, the article may be a product or a box such as a tool box.

The estimation device 10 is connected to the mobile body 51 via a communication network. The type of communication network is not particularly limited and may be a wired or wireless network. The communication network may be constituted by multiple communication networks. The configuration of the communication network by which the estimation device 10 is connected to the mobile body 51 and the like is not particularly limited.

The mobile body 51 only needs to be, for example, a device that can move in the facility. The mobile body 51 may be, for example, a mobile robot capable of autonomous travel, or a drone. The type of the mobile body 51 is not particularly limited. The imaging device 52 can move along with the movement of the mobile body 51. A control device (not illustrated) that controls the mobile body is capable of controlling the mobile body 51 and can change a position of the imaging device 52 by changing a position of the mobile body 51.

The estimation device 10 can acquire a captured image captured by the imaging device 52 from the mobile body 51 via the communication network.

FIG. 1 illustrates an example in which the imaging device 52 is installed in the mobile body 51 and is movable. However, the imaging device 52 may be a fixedly arranged device. A plurality of imaging devices 52 may be fixedly arranged in the facility. The imaging device 52 may be an independent device. The imaging device 52 may be provided in a terminal portable by a user. The type of the terminal is not particularly limited and may be a smartphone, a tablet-type terminal, a personal computer (PC), or the like. The imaging device 52 may be provided in a wearable device such as smart glasses.

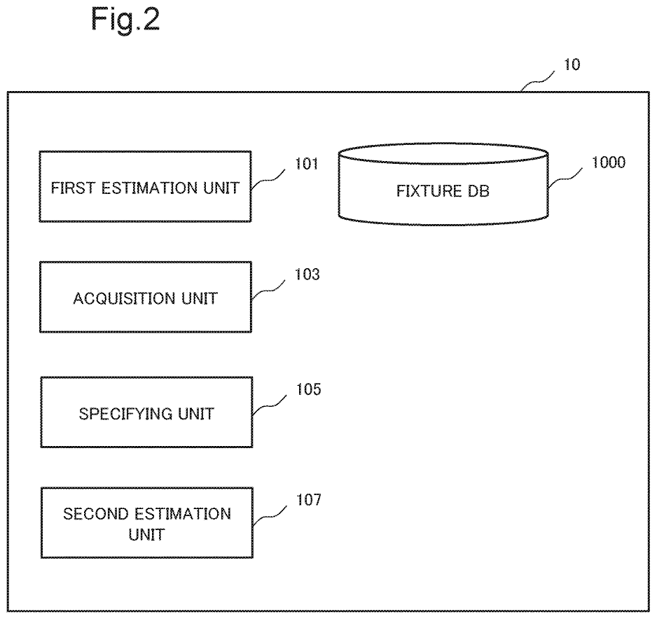

FIG. 2 is a block diagram illustrating a configuration example of the estimation device 10. In FIG. 2, the estimation device 10 includes a first estimation unit 101, an acquisition unit 103, a specifying unit 105, and a second estimation unit 107. The various functional units, for example, store or read an intermediate result, a result, and the like in a storage device or the like as appropriate.

Furthermore, the estimation device 10 may include a fixture database (DB) 1000. For example, the fixture DB 1000 stores, for each fixture, fixture identification information that identifies a fixture, and information regarding the fixture in association with each other. The information regarding the fixture may be, for example, information regarding the size of the fixture. The information regarding the size of the fixture is not limited to the lateral width, depth, and height of the entire fixture, but may include the lateral width, depth, and height of each shelf of the fixture. The information regarding the fixture may include information regarding an installation position of the fixture in the facility.

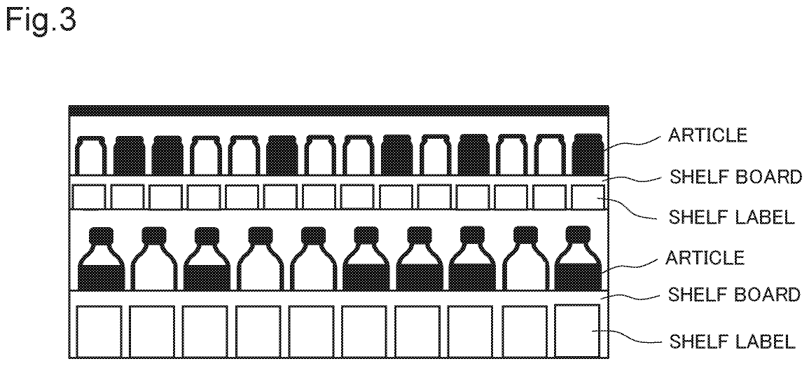

FIG. 3 is an explanatory diagram illustrating an example of the fixture. In FIG. 3, the fixture includes, for example, a plurality of shelves. A shelf label is installed on a shelf board that separates shelves of each fixture. For example, in a case where articles packed in small bottles, such as spices, are placed at a high density, an interval between the articles is narrow, and thus an interval between the shelf labels is also narrow. Therefore, as described above, when the interval between the shelf labels is narrow, it may sometimes be difficult to estimate sections of the articles by using the shelf labels.

Here, a code or the like indicating the fixture identification information capable of identifying a fixture may be attached to the fixture. The code may be represented by a one-dimensional code such as a barcode, or a two-dimensional code.

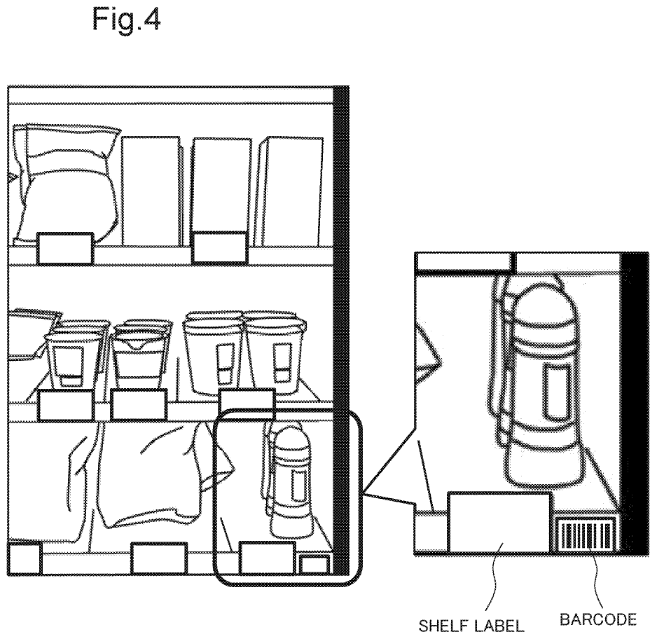

FIG. 4 is an explanatory diagram illustrating an example in which a barcode capable of identifying a fixture is attached to a shelf board of the fixture. For example, when a barcode is recognized from a captured image, the fixture identification information indicated by the barcode can be specified. For example, the estimation device 10 can acquire the information regarding the fixture associated with the fixture identification information, from the fixture DB 1000.

The first estimation unit 101 estimates the number of shelf labels installed on the fixture and an interval between the shelf labels by performing image recognition on an image of the fixture captured by the imaging device 52. The interval between shelf labels is an interval between two adjacent shelf labels. Specifically, for example, the first estimation unit 101 estimates an article section with the shelf label, for example, by performing image recognition on an image of the fixture captured by the imaging device 52. At that time, the first estimation unit 101 estimates the number of shelf labels and an interval between the shelf labels. Known techniques can be used as a technique for recognizing a shelf label by image recognition from an image obtained by imaging the fixture and a technique for estimating an article section with shelf labels.

The acquisition unit 103 acquires a distance from the imaging device 52 to the fixture when the image is captured. This distance will be referred to as an imaging distance. For example, in a case where the imaging device 52 is fixedly arranged, the acquisition unit 103 acquires, as the imaging distance, a distance from a position where the imaging device 52 is installed to a position where the fixture is installed, which is stored in a storage device. As for the position where the imaging device 52 is installed, a database for managing the imaging device 52 and the like may be prepared in advance, and the acquisition unit 103 may acquire the position where the imaging device 52 is installed, from the prepared database. The acquisition unit 103 may acquire the position where the fixture is installed from the fixture DB 1000. A method for specifying which fixture is imaged will be described later.

For example, a case where the imaging device 52 is provided in the mobile body 51 will be described. For example, the control device that controls the mobile body 51 holds information regarding the size of the fixture and an angle of view of the imaging device 52 in order to cause the imaging device 52 to image the fixture. Then, the control device calculates a position where the fixture is supposed to fit within the angle of view of the imaging device 52, moves the mobile body 51 to the calculated position, and causes the imaging device 52 to image the fixture. For this reason, the device that controls the mobile body 51 stores the imaging distance from the fixture to the imaging device 52 at the time of imaging. Therefore, the acquisition unit 103 acquires the imaging distance from the control device that controls the mobile body 51. For example, the control device and the estimation device 10 may be connectable via the communication network. For example, the acquisition unit 103 may receive the imaging distance from the control device that controls the mobile body 51.

As another method for acquiring the imaging distance, the acquisition unit 103 may acquire posture information on the imaging device 52 from the control device that controls the mobile body 51 equipped with the imaging device 52. Then, the acquisition unit 103 may calculate the imaging distance from the imaging device 52 to the fixture, based on the size of the fixture included in the fixture DB 1000 and the posture information on the imaging device 52. The posture information on the imaging device 52 is, for example, information such as roll that is an inclination in a lateral direction, pitch that is an inclination in a front-rear direction, and yaw that is an inclination in a rotation direction when the imaging device 52 is viewed from above. An existing technique can be used as a method for calculating the imaging distance from the imaging device 52 to the fixture based on the size of the fixture and the posture information on the imaging device 52, and thus a detailed description thereof will be omitted. Specifically, for example, the acquisition unit 103 may specify which fixture is imaged, by acquiring the fixture identification information from the control device that controls the mobile body 51, or may specify which fixture is imaged, by acquiring the fixture identification information by using a code attached to the fixture as will be described later. Therefore, the acquisition unit 103 may calculate the imaging distance from the imaging device 52 to the fixture, based on the size of the fixture associated with the acquired fixture identification information in the fixture DB 1000, and the posture information on the imaging device 52.

In a case where a wearable device equipped with the imaging device 52 is used, the acquisition unit 103 may acquire the posture information on the imaging device 52 from the wearable device. Then, as described above, the acquisition unit 103 may calculate the imaging distance from the imaging device 52 to the fixture, based on the size of the fixture and the posture information on the imaging device 52.

The specifying unit 105 specifies an error in posture correction of the imaging device 52, based on the imaging distance. The error in posture correction is a spatial error. Specifically, for example, the specifying unit 105 may calculate the error, using following Formula (1).

ERROR≈IMAGING DISTANCE×tan (|ANGLE ERROR IN POSTURE|) Formula (1)

The inventors generated a captured image in which a fixture was captured in a virtual space, and conducted accuracy evaluation on an approach for estimating a relative posture of the imaging device 52 with respect to the fixture. The number of captured images was 5000.

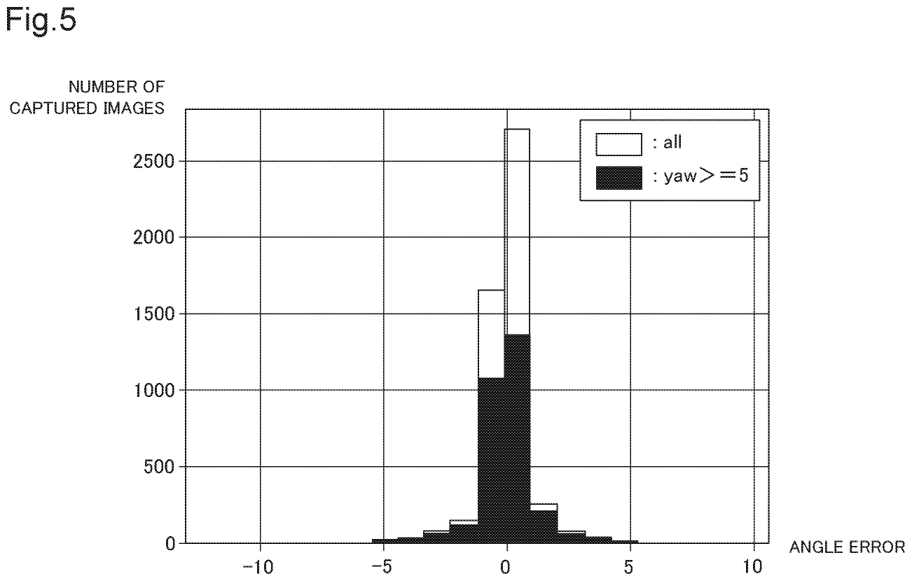

FIG. 5 is an explanatory diagram representing the number of captured images and the angle error in posture. In the graph, the vertical axis denotes the number of captured images, and the horizontal axis denotes the angle error in posture. The unit of the angle error in posture is °.

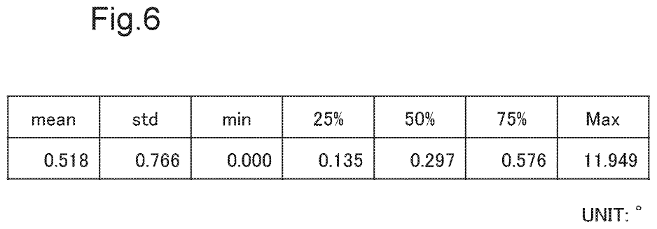

FIG. 6 is an explanatory diagram illustrating an example of an evaluation result on the angle error in posture. In FIG. 6, the evaluation result indicates an angle error in posture at each of the average (mean), the standard deviation (std), the minimum value (min), 25%, 50%, 75%, and the maximum value (max). The statistical values illustrated in FIG. 6 are calculated using the absolute values of the angle errors shown in FIG. 5. In FIG. 6, the unit of the angle error in posture is °. Note that 25%, 50%, and 75% denote values corresponding to 25%, 50%, and 75% from the smallest of the 5000 angle errors.

According to FIGS. 5 and 6, the average angle error is about 0.5°, and about 90% of all errors are 1° or less. The maximum error is about 12° (11.949° in FIG. 6). Since the maximum error is a case where the captured image does not satisfy the requirements necessary for estimation, the accuracy of posture correction of the imaging device 52 is regarded as an error of around 1° in this evaluation.

For example, 1° is set as the angle error in posture in above Formula (1). In a case where the imaging distance is one meter, the specifying unit 105 can calculate an error of about two centimeters (cm) by using Formula (1). In a case where an article section (an interval between shelf labels) estimated by detection of the shelf labels by image recognition is less than this error, it is difficult to estimate the section.

Here, an example has been described in which the specifying unit 105 calculates the error in posture correction by using Formula (1). For example, the errors in posture correction calculated for each imaging distance may be tabulated, and the specifying unit 105 may specify the error in posture correction relevant to the imaging distance from the table.

In a case where the estimated interval between the shelf labels is less than the error, the second estimation unit 107 estimates the article section on the fixture by dividing the width of the fixture by the number of shelf labels. The estimated interval between the shelf labels may be a statistic of intervals between the shelf labels. The statistics include an average value, a median value, a mode value, a maximum value, and a minimum value and are not particularly limited. Describing an example of the minimum value, in a case when the estimated interval between shelf labels having the narrowest width (minimum value) is less than the error, the second estimation unit 107 estimates the article section on the fixture by dividing the width of fixture by the number of shelf labels.

Specifically, the second estimation unit 107 may only output information representing a range, a boundary value, or the like of an article represented by the shelf labels with coordinate values in an image obtained by imaging the fixture, as information regarding the article section. The coordinate values include an x coordinate value, a y coordinate value, and the like, for example. The width of the fixture may be the lateral width of the entire fixture or may be the lateral width of each shelf.

Here, the width of the fixture may be estimated by image recognition. For example, the first estimation unit 101 may further estimate the width of the fixture by image recognition on the captured image. For example, the first estimation unit 101 may detect a shelf board by image recognition on a captured image and detect the width of the shelf board as the width of the fixture. Alternatively, for example, the first estimation unit 101 may estimate the width of the fixture from the arrangement of shelf labels and products. The acquisition unit 103 may acquire the width of the fixture together with the imaging distance from the control device that controls the mobile body 51. For example, the width of the fixture may be acquired from the fixture DB 1000. The width of the fixture may be the lateral width of the entire fixture or may be the lateral width of each shelf. As to which fixture is included in the captured image, for example, a code capable of identifying the fixture may be given to each fixture. The code may be the whole fixture identification information in the fixture DB 1000, or may be obtained by representing the fixture identification information with a one-dimensional code or a two-dimensional code. That is, the code includes the fixture identification information. In a case where the estimated interval between the shelf labels is less than the error, the second estimation unit 107 estimates the article section on the fixture by dividing, by the number of shelf labels, the width of the fixture associated with the fixture identification information included in the code in the fixture DB 1000 that stores the fixture identification information and the width of the fixture in association with each other for each fixture.

A specific example will be described with reference to FIG. 4. In the example in FIG. 4, for example, in a case where the estimated interval between the shelf labels is less than the error, the second estimation unit 107 acquires, from the fixture DB 1000, the width of the fixture associated with the fixture identification information indicated by the barcode recognized from the captured image. The second estimation unit 107 then estimates the article section on the fixture by dividing the acquired width of the fixture by the number of shelf labels.

In a case where the estimated interval between the shelf labels is not less than the error, the estimation result on the article section by the first estimation unit 101 can be used.

In the fixture DB 1000, an estimation result by the first estimation unit 101, an estimation result by the second estimation unit 107, and the like may be registered.

For example, the estimation result on the article section may also be linked with data or the like obtained by another sensor and registered in various databases. The another sensor may be installed in the mobile body 51 similarly to the imaging device 52. Examples of the data obtained by the another sensor include data regarding inventory quantity in the fixture, data regarding the environment of the fixture, such as temperature and humidity, and point cloud data representing the fixture that is obtained by light detection and ranging (LiDAR) or the like. The estimation result on the article section may be used to visualize the fixture in a virtual space.

### Flowchart

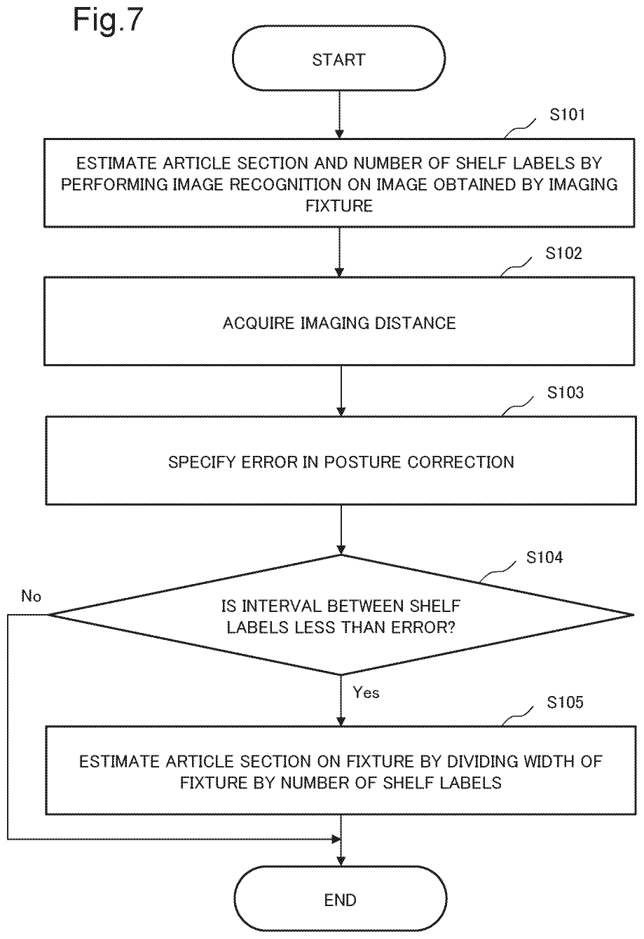

FIG. 7 is a flowchart illustrating an operation example of the estimation device 10. The first estimation unit 101 estimates an article section and the number of shelf labels by performing image recognition on an image obtained by imaging a fixture (step S101). The acquisition unit 103 acquires the imaging distance from the imaging device 52 to the fixture when the image is captured (step S102).

The specifying unit 105 specifies an error in posture correction of the imaging device 52, based on the imaging distance (step S103).

The second estimation unit 107 determines whether the estimated interval between the shelf labels is less than the error (step S104). In a case where the estimated interval between the shelf labels is not less than the error (step S104: No), the estimation device 10 ends the series of processes illustrated in FIG. 7. That is, the article section estimated by the first estimation unit 101 is used. On the other hand, in a case where the estimated interval between the shelf labels is less than the error (step S104: Yes), the second estimation unit 107 estimates the article section on the fixture by dividing the width of the fixture by the number of shelf labels (step S105). Then, the estimation device 10 ends the series of processes illustrated in FIG. 7.

In order to project the article section estimated using image recognition on the captured image onto a three-dimensional space, the posture information on the imaging device 52 is required. As described above, the current accuracy of posture correction of the imaging device 52 is assumed to have an error of around one degree. As described above, for example, in a case where the imaging distance from the imaging device 52 to the fixture is one meter, the error is about two centimeters.

Accordingly, the estimation device 10 estimates the number of shelf labels installed on the fixture and the interval between the shelf labels as the article section on the fixture by performing image recognition on the image of the fixture captured by the imaging device 52. The estimation device 10 acquires the imaging distance from the imaging device 52 to the fixture when the image is captured. The estimation device 10 specifies an error in posture correction of the imaging device 52, based on the imaging distance. In a case where the estimated interval between the shelf labels is less than the error, the estimation device 10 estimates the article section on the fixture by dividing the width of the fixture by the number of shelf labels. In this manner, in a case where the estimated interval between the shelf labels is less than the error in posture correction, the estimation device 10 estimates the article section by dividing the width of fixture by the number of shelf labels. As a result, even in a case where the display density of articles is high, the article section can be estimated. Consequently, the estimation accuracy for the article section can be improved.

Thus, the description of the example embodiments has ended. The example embodiments are not limited to the examples described above and can be variously changed. Modified examples will be described hereinafter.

### First Modified Example

The control device that controls the mobile body 51 and the estimation device 10 may be the same device. In this case, the acquisition unit 103 may only acquire the imaging distance used to control the mobile body 51 from a storage device or the like.

### Second Modified Example

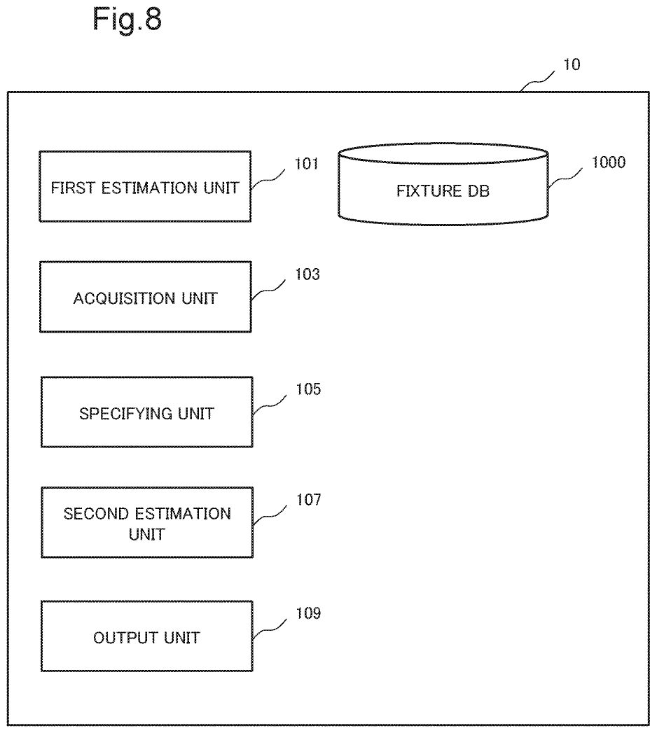

FIG. 8 is a block diagram illustrating another configuration example of the estimation device 10. For example, the estimation device 10 may further include an output unit 109 in addition to the functional units illustrated in FIG. 2. For example, the output unit 109 may output the information regarding the article section to the terminal of the user. The type of the terminal is not particularly limited and may be a smartphone, a tablet-type terminal, a PC, or the like. The output method is not particularly limited, and examples thereof include display. Specifically, for example, the output unit 109 may emphasize a boundary or the like, which is an article section, in the captured image obtained by imaging the fixture and display the boundary or the like on the terminal of the user.

Thus, the description of the first and second modified examples has ended. The example embodiments and the modified examples may be combined with each other as appropriate. There is no particular limitation on how the example embodiments are combined with each other. The example embodiments and the modified examples may be combined as appropriate. How the example embodiments and the modified examples are combined is not particularly limited.

The configuration of the estimation device 10 is not particularly limited. For example, the functional units of the estimation device 10 may be implemented by one device. Alternatively, for example, the functional units of the estimation device 10 or databases may be implemented by different devices from each other and may be configured as a system. For example, the functional units of the estimation device 10 may be configured with a plurality of servers and implemented as a distributed system. For example, a system including a database server including databases and a server including the functional units of the estimation device 10 may be implemented. A system including a server including a part of the functional units of the estimation device 10 and a server including another part of the functional units of the estimation device 10 may be implemented. The number of servers is not particularly limited.

The fixture DB and various kinds of information are examples and may further include other information or may not include some information. The fixture DB may be further divided into a plurality of DBs, and the configuration of each DB is not particularly limited.

In the second modified example, the process of generating information or the like to be displayed on the terminal of the user may be performed by a functional unit included in the estimation device 10, such as the output unit 109. This process may be performed by the terminal. That is, the terminal may generate screen information to be displayed on the terminal, based on data received from the estimation device 10, and display a screen, based on the screen information.

### (Hardware Configuration Example of Computer)

Next, a hardware configuration example in a case where each device such as the estimation device 10, the mobile body 51, and the terminal of the user is implemented by a computer will be described.

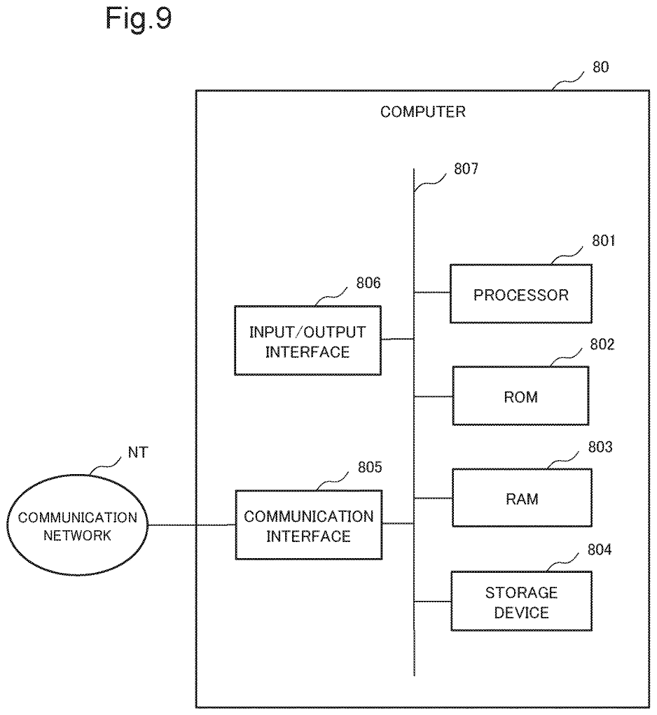

FIG. 9 is an explanatory diagram illustrating a hardware configuration example of a computer. For example, some or all of the devices can also be implemented using any combination of a computer 80 as illustrated in FIG. 9 and a program.

The computer 80 includes, for example, a processor 801, a read only memory (ROM) 802, a random access memory (RAM) 803, and a storage device 804. The computer 80 also includes a communication interface 805 and an input/output interface 806. The constituent members are connected to each other via a bus 807, for example. The number of constituent members is not particularly limited, and the number of constituent members is one or multiple.

The processor 801 controls the entire computer 80. As the processor 801, for example, a central processing unit (CPU), a digital signal processor (DSP), a graphics processing unit (GPU), a physics processing unit (PPU), a tensor processing unit (TPU), a quantum processor, or a combination thereof, or the like can be used and is not particularly limited. The processor 801 may be a single-core processor or a multi-core processor.

The computer 80 includes the ROM 802, the RAM 803, and the storage device 804, for example. Examples of the storage device 804 include a semiconductor memory such as a flash memory, a hard disk drive (HDD), a solid state drive (SSD), and an optical disc. These may be used alone or in combination of two or more. For example, the storage device 804 stores an operating system (OS) program, an application program, a program according to the example embodiments, and the like. Alternatively, the ROM 802 stores an application program, a program according to the example embodiments, and the like. The RAM 803 is used as a work area for the processor 801.

The processor 801 loads a program stored in the storage device 804, the ROM 802, or the like. The processor 801 executes each process coded in the program. The processor 801 may download various programs via the communication network NT. The processor 801 functions as a part or the whole of the computer 80. Based on the program, the processor 801 may execute the processes or instructions in the flowchart illustrated in the drawing.

The communication interface 805 is connected to the communication network NT such as a local area network (LAN) or a wide area network (WAN) through a wireless or wired communication line. The communication network NT may be constituted by a plurality of communication networks NT. As a result, the computer 80 is connected to an external device or an external computer 80 via the communication network NT. The communication interface 805 takes control of an interface between the communication network NT and the inside of the computer 80. The communication interface 805 controls input and output of data from and to the external device or the external computer 80.

The input/output interface 806 is connected to at least one of an input device, an output device, and an input/output device. A method of the connection may be wireless or wired. Examples of the input device include a keyboard, a mouse, and a microphone. Examples of the output device include a display device, a lighting device (such as a lamp), and a sound output device that outputs a sound. Examples of the input/output device include a touch panel display. The input device, the output device, the input/output device, and the like may be built in the computer 80 or may be externally attached to the computer 80. That is, for example, the computer 80 may include an input device such as a keyboard or a mouse. The computer 80 may include an output device such as a display. The computer 80 may include each of an input device, an output device, and an input/output device.

The hardware configuration of the computer 80 is an example. The computer 80 may include some components illustrated in FIG. 9. The computer 80 may include a component other than those illustrated in FIG. 9. For example, the computer 80 may include a drive device. The processor 801 may read a program or data stored in a recording medium mounted on the drive device or the like into the RAM 803. Examples of the non-transitory tangible recording medium include an optical disc, a flexible disk, a magneto-optical disk, and a universal serial bus (USB) memory.

The computer 80 may include various sensors (not illustrated). The types of sensors are not particularly limited. The computer 80 may include an imaging device capable of capturing images and videos.

Thus, the description of the hardware configuration of each device has ended. A method for implementing each device has various modified examples. For example, each device may be implemented by any combination of a computer and a program different for each component. A plurality of components included in each device may be implemented by any one combination of a computer and a program.

Some or all of the components of each device may be implemented by an application specific circuit. Some or all of the components of each device may be implemented by a general-purpose circuit such as a field programmable gate array (FPGA). Some or all of the components of each device may be implemented by a combination of an application specific circuit, a general-purpose circuit, and the like. These circuits each may be a single integrated circuit. Alternatively, these circuits each may be divided into a plurality of integrated circuits. The plurality of integrated circuits may be configured by being connected via a bus or the like.

In a case where some or all of the components of each device are implemented by a plurality of computers, circuits, and the like, the plurality of computers, circuits, and the like may be arranged in a centralized manner or in a distributed manner.

The estimation method described in each example embodiment may be implemented by causing a computer such as the estimation device 10 to execute the estimation method.

Each program described in each example embodiment is recorded in a computer-readable recording medium such as an HDD, an SSD, a flexible disk, an optical disc, a magneto-optical disk, or a USB memory. Each program is read from the recording medium by the computer to be executed. Each program may be distributed via the communication network NT.

The function of each component of the estimation device 10 described above may be implemented by dedicated hardware such as a computer. Alternatively, each component may be implemented by software. Alternatively, each component may be implemented by a combination of hardware and software.

While the present disclosure has been particularly shown and described with reference to example embodiments thereof, the present disclosure is not limited to these example embodiments. The configurations and details of the present disclosure may include example embodiments to which various changes that can be grasped by those skilled in the art within the scope of the present disclosure are applied. The present disclosure may include example embodiments in which the matters described in the present specification are appropriately combined or replaced, as necessary. For example, the matters described with a specific example embodiment can be applied to other example embodiments as long as no contradiction occurs. For example, although a plurality of operations is described in order in the form of a flowchart, the described order does not limit the order in which the plurality of operations is executed. Therefore, when each example embodiment is carried out, the order of the plurality of operations can be changed within a range that does not interfere with the content.

Some or all of the example embodiments described above may also be described as Supplementary Notes below. However, some or all of the example embodiments described above are not limited to the following.

### (Supplementary Note 1)

An estimation device including:
a first estimation unit for estimating a number of shelf labels installed on a fixture and an interval between the shelf labels as an article section on the fixture by performing image recognition on an image of the fixture captured by an imaging device;
an acquisition unit for acquiring an imaging distance from the imaging device to the fixture when the image is captured;
a specifying unit for specifying an error in posture correction of the imaging device, based on the imaging distance; and
a second estimation unit for estimating the article section on the fixture by dividing a width of the fixture by the number of shelf labels in a case where the estimated interval between the shelf labels is less than the error.

### (Supplementary Note 2)

The estimation device according to Supplementary Note 1, in which
the imaging device is installed in a mobile body.

### (Supplementary Note 3)

The estimation device according to Supplementary Note 1 or 2, in which
a code indicating fixture identification information capable of identifying the fixture is attached to the fixture, and
in a case where the estimated interval between the shelf labels is less than the error, the second estimation unit estimates the article section on the fixture captured in the image, by dividing, by the number of the shelf labels, the width of the fixture associated with the fixture identification information indicated by the code in a fixture database that stores the fixture identification information and the width of the fixture for each of the fixtures in association with each other.

### (Supplementary Note 4)

The estimation device according to any one of Supplementary Notes 1 to 3, in which
the specifying unit calculates the error in posture correction of the imaging device, based on a set angle error of a posture of the imaging device and the imaging distance.

### (Supplementary Note 5)

An estimation method including:
by a computer,
estimating a number of shelf labels installed on a fixture and an interval between the shelf labels as an article section on the fixture by performing image recognition on an image of the fixture captured by an imaging device;
acquiring an imaging distance from the imaging device to the fixture when the image is captured;
specifying an error in posture correction of the imaging device, based on the imaging distance; and
estimating the article section on the fixture by dividing a width of the fixture by the number of shelf labels in a case where the estimated interval between the shelf labels is less than the error.

### (Supplementary Note 6)

A program for causing
a computer to execute:
estimating a number of shelf labels installed on a fixture and an interval between the shelf labels as an article section on the fixture by performing image recognition on an image of the fixture captured by an imaging device;
acquiring an imaging distance from the imaging device to the fixture when the image is captured;
specifying an error in posture correction of the imaging device, based on the imaging distance; and
estimating the article section on the fixture by dividing a width of the fixture by the number of shelf labels in a case where the estimated interval between the shelf labels is less than the error.

### (Supplementary Note 7)

A non-transitory recording medium readable by a computer, the non-transitory recording medium recording a program for causing
the computer to execute:
estimating a number of shelf labels installed on a fixture and an interval between the shelf labels as an article section on the fixture by performing image recognition on an image of the fixture captured by an imaging device;
acquiring an imaging distance from the imaging device to the fixture when the image is captured;
specifying an error in posture correction of the imaging device, based on the imaging distance; and
estimating the article section on the fixture by dividing a width of the fixture by the number of shelf labels in a case where the estimated interval between the shelf labels is less than the error.

Some or all of the configurations described in Supplementary Notes 2 to 4 dependent on the above-described Supplementary Note 1 can also be dependent on Supplementary Notes 5, 6, and 7 with a dependency relationship similar to that of Supplementary Notes 2 to 4. Furthermore, some or all of the configurations described as Supplementary Notes can be similarly dependent on not only Supplementary Notes 1, 5, 6, and 7, but also various pieces of hardware and software, and a variety of recording means for recording software, or a system without departing from the above-described example embodiments.

According to the present disclosure, estimation of an article section can be enabled even in a case where articles are placed on a fixture at a high density.

1. An estimation device comprising:
at least one memory configured to store instructions; and
at least one processor configured to execute the instructions to:
estimate a number of shelf labels installed on a fixture and an interval between the shelf labels as an article section on the fixture by performing image recognition on an image of the fixture captured by an imaging device;
acquire an imaging distance from the imaging device to the fixture when the image is captured;
specify an error in posture correction of the imaging device, based on the imaging distance; and
estimate the article section on the fixture by dividing a width of the fixture by the number of shelf labels in a case where the estimated interval between the shelf labels is less than the error.

2. The estimation device according to claim 1, wherein
the imaging device is installed in a mobile body.

3. The estimation device according to claim 1, wherein
a code indicating fixture identification information capable of identifying the fixture is attached to the fixture, and the at least one processor is further configured to execute the instructions to:
in a case where the estimated interval between the shelf labels is less than the error, estimate the article section on the fixture captured in the image, by dividing, by the number of the shelf labels, the width of the fixture associated with the fixture identification information indicated by the code in a fixture database that stores the fixture identification information and the width of the fixture for each of the fixtures in association with each other.

4. The estimation device according to claim 1, wherein the at least one processor is further configured to execute the instructions to: calculate the error in posture correction of the imaging device, based on a set angle error of a posture of the imaging device and the imaging distance.

5. An estimation method comprising:
by a computer,
estimating a number of shelf labels installed on a fixture and an interval between the shelf labels as an article section on the fixture by performing image recognition on an image of the fixture captured by an imaging device;
acquiring an imaging distance from the imaging device to the fixture when the image is captured;
specifying an error in posture correction of the imaging device, based on the imaging distance; and
estimating the article section on the fixture by dividing a width of the fixture by the number of shelf labels in a case where the estimated interval between the shelf labels is less than the error.

6. A non-transitory recording medium readable by a computer, the non-transitory recording medium recording a program for causing
the computer to execute:
estimating a number of shelf labels installed on a fixture and an interval between the shelf labels as an article section on the fixture by performing image recognition on an image of the fixture captured by an imaging device;
acquiring an imaging distance from the imaging device to the fixture when the image is captured;
specifying an error in posture correction of the imaging device, based on the imaging distance; and
estimating the article section on the fixture by dividing a width of the fixture by the number of shelf labels in a case where the estimated interval between the shelf labels is less than the error.
